(19) United States
(12) Patent Application Publication
(10) Pub. No.: US 2006/0259451 A1
(43) Pub. Date: Nov. 16, 2006

(54) Method of using a workflow and a system for use with the method

(75) Inventor: John K. Gibbons, Center Point, TX (US)

Correspondence Address: LARSON NEWMAN ABEL;POLANSKY & WHITE, LLP, 5914 WEST COURTYARD DRIVE, SUITE 200, AUSTIN, TX, 78730, US

(73) Assignee: PlanView, Inc., Austin, TX (US)

(21) Appl. No.: 11/314,430

(22) Filed: Dec. 20, 2005

Related U.S. Application Data
(60) Provisional application No. 60/681,372, filed on May 16, 2005.

(51) Int. Cl. G06F 17/30

(52) U.S. Cl. 707/1

(57) ABSTRACT

A bypass function can be included within workflow to bypass a plurality of actions within a column. In one embodiment, the generation of the workflow can include a conditional logic test that may be performed when subsequently using the workflow to determine if, at that subsequent time, the remaining actions within a column are to be performed depending on a result of the conditional logic test. A system can perform the conditional logic test at the appropriate time in the workflow and determine the result that is utilized in determining whether remaining actions within the column are to be bypassed. In one embodiment, actions can be indicated as bypassed and information regarding the workflow stored, displayed to a user, or a combination thereof.

### RELATED APPLICATION

This is related to and claims priority under 35 U.S.C. § 119(e) to United States Patent Application No. 60/681,372 entitled “Method of Using a Workflow and a System For Use With the Method” by Gibbons on May 16, 2005, which is assigned to the current assignee hereof and incorporated herein by reference in its entirety.

### FIELD OF THE DISCLOSURE

The disclosure relates in general to methods and systems, and more particularly, to a method of using a workflow and a system for use with the method.

### DESCRIPTION OF THE RELATED ART

Many commercially available software products exist for developing and executing actions for a project workflow. At least one of the software products can allow for a single action to be skipped. Actual workflows can be very complex and involve numerous actions that may not be performed. Skipping each action can be done manually, however, the process can be long and prone to human error for complex workflows. With a complex project workflow, an action that is not to be skipped is more likely to be incorrectly skipped (action not performed), and an action that is to be skipped is more likely to be performed.

Another software product may allow an action to be skipped based merely on the passage of time. For example, if an action is not completed by a predetermined time, the action is skipped. Actual workflows may have actions that can be conditions but are not solely based on the passage of time. For example, an action related to a business imperative of an entity should be addressed and should not be skipped merely due to a time-out situation.

Other commercially available software products may allow the definition of a conditional test to determine whether to start a sequence of workflow actions. However, in actual workflows, a plurality of such sequences may occur in parallel, including any combination of conditional and unconditional processes, with further actions to be performed when all of the unconditional sequences are completed as well as all of the conditional sequences that actually require performance in a particular case. With only conditional logic to start a sequence, the logic at the conclusion of the plurality of sequences becomes more complex and subject to error, as it is necessary to retest for each sequence in the plurality whether it was completed or in fact unneeded.

### BRIEF DESCRIPTION OF THE DRAWINGS

The present invention is illustrated by way of example and not limitation in the accompanying figures, in which the same reference number indicates similar elements in the different figures.

FIG. 1 includes an illustration of a system for using a workflow.

FIG. 2 includes an illustration of a portion of a workflow after an action has been completed.

FIGS. 3-5 include a flowchart for a software program that can be used with the workflow in accordance with an embodiment.

FIG. 6 includes an illustration of a portion of the workflow of FIG. 2 after a plurality of actions has been bypassed.

FIG. 7 includes an illustration of a portion of the workflow of FIG. 6 after all actions within parallel columns have been bypassed or completed.

FIGS. 8 to 10 include illustrations of portions of workflows in accordance with other embodiments.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A bypass function can be included within workflow to bypass a plurality of actions within a column. In one embodiment, the generation of the workflow can include a conditional logic test that may be performed when subsequently using the workflow to determine if, at that subsequent time, the remaining actions within a column are to be performed depending on a result of the conditional logic test. A system can perform the conditional logic test at the appropriate time in the workflow and determine the result that is utilized in determining whether remaining actions within the column are to be bypassed. In one embodiment, actions can be indicated as bypassed and information regarding the workflow stored, displayed to a user, or a combination thereof. The methods and systems described herein are not as slow or error prone as conventional single action skips.

A few terms are defined or clarified to aid in understanding the terms as used throughout this specification. The term “action element” is intended to mean an element that is associated with an action.

The term “bypass” is intended to mean an action wherein a plurality of actions are omitted based upon a result of a test that is not solely based on a passage of time. The test may directly or indirectly involve the passage of time, but is not solely based on time. For example, a test can be whether the then-current value of an asset at a later time exceeds a predetermined amount. Note that the then-current value may depend on the asset's principal, the interest rate, and time; the then-current value is not solely based on the passage of time.

The term “column” is intended to mean at least a portion of a workflow that includes one or more actions, or any combination of one or more actions and one or more row element that are designed to be performed serially. Note that the performance of one or more actions within a column may be conditional. A column element may be used within a data model to represent a column, and therefore, for the purposes of this speciation, column and column element can be used interchangeably.

The term “dummy element” is intended to mean an element that can be indicated as completed when or shortly (e.g., less than a second) after activating the element. If the dummy element is an action element, the dummy element has no associated action, if the dummy element is a column, the dummy element has no associated action element, and the dummy element is a row element, the dummy element has no associated column.

The term “element” is intended to mean an object that is associated with an action, a column, or a row (e.g., a set of parallel columns).

The term “row element” is intended to mean an element that is related to a plurality of parallel columns.

The phrase “from element X, a command Y is used” is intended to mean that through the medium of typed commands or a graphical user interface (GUI), a user points to, identifies, or references a particular element X, and then invokes a command Y to achieve the ends described in the context of the phrase. The identification of the element X may be a separate GUI action from invoking the command (as in clicking on the step to highlight it or give it focus), followed by a separate GUI action (such as clicking on a choice in a separate menu, button bar, or other GUI control) to invoke the command Y, or the two actions may be combined by having a menu or buttons within element X or otherwise made available directly by clicking on element X, or one or both parts may be accomplished by typing at a keyboard.

The phrase “element Y can include a reference to element X” is intended to mean that the data representation of element Y may include a direct or indirect pointer or key identifying or allowing the identification of element X. For example, elements X and Y are consecutive elements of column C. In one embodiment, element Y may include a direct pointer or key identifying or allowing the identification of element A. In another embodiment, each of elements X and Y may include a direct pointer or key identifying or allowing the identification of column C. Element Y is the immediate successor to element X because among the elements comprising column C, element Y has the lowest sequence number greater than that of X. Therefore, in this embodiment, element Y includes an indirect pointer or key identifying or allowing the identification of element X, via the direct pointer or key identifying or allowing the identification of column C and the sequence numbering of column C.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one, and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware, and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing details of the embodiments of the present invention, a non-limiting, illustrative hardware architecture for using embodiments is described. After reading this specification, skilled artisans will appreciate that many other hardware architectures can be used in carrying out embodiments described herein.

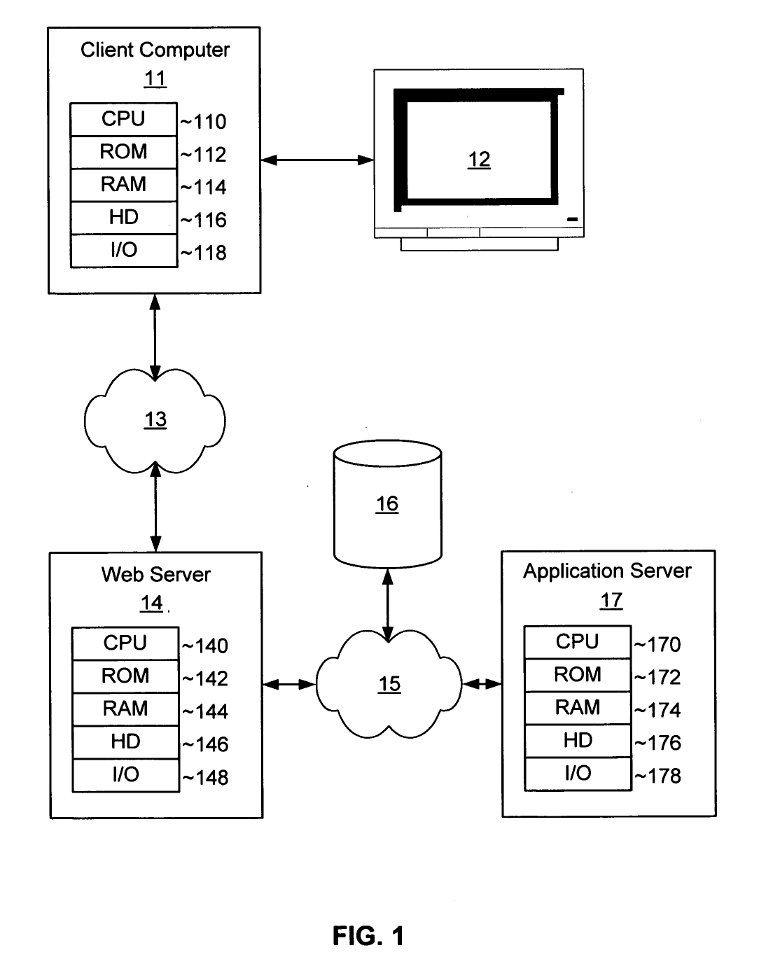

FIG. 1 includes an illustration of a system that can be used in a method of using a workflow. The system can include a client computer 11 that is bi-directionally coupled to a monitor 12 and a network 13. The system can also include a web server 14 that is bi-directionally coupled to networks 13 and 15. The networks 13 and 15 may be the same or different networks. For example, the network 13 can be the Internet, and the network 15 can be an internal network for an entity. The network 15 can be bi-directionally coupled to a database 16 and an application server 17.

In one implementation, the client computer 11 may include a central processing unit (“CPU”) 110, a read-only memory (ROM) 112, a random access memory (“RAM”) 114, a hard drive (“HD”) or storage memory 116, and input/output device(s) (“I/O”) 118. The I/O 118 can include a keyboard, printer, electronic pointing device (e.g., mouse, trackball, etc.), or the like. The monitor 12 can be part of the I/O 118, but is illustrated separately in order to more clearly describe the method and information that may be displayed at the monitor 12. The web server 14 may include a central processing unit (“CPU”) 140, a read-only memory (ROM) 142, a random access memory (“RAM”) 144, a hard drive (“HD”) or storage memory 146, and I/O 148. The I/O 148 can include a keyboard, a monitor, printer, electronic pointing device (e.g., mouse, trackball, etc.), or the like. The application server 17 may include a central processing unit (“CPU”) 170, a read-only memory (ROM) 172, a random access memory (“RAM”) 174, a hard drive (“HD”) or storage memory 176, and I/O 178. The I/O 178 can include a keyboard, monitor, printer, electronic pointing device (e.g., mouse, trackball, etc.), or the like. Although not illustrated, other connections and additional memory may be coupled to or reside within each of the client computer 11, the web server 14, the application server 17, or any combination thereof. The web server 14, the application server 17, or both can be standalone server computers or may be one or more blades within a distributed computing environment.

The database 16 may reside external to the web server 14 and the application server 17, as illustrated in FIG. 1, or may reside on HD 146 (web server 14) or HD 176 (application server 17) if the database is not too large. The database 16 can include nearly any type of information within one or more database tables. In one embodiment, the database 16 may also include logic used in carryout any one or more portions of the methods described herein.

Each of the client computer 11, the web server 14, the application server 17, or any combination thereof is an example of a data processing system. ROM (112, 142, 172), RAM (114, 144, 174), HD (116, 146, 176), and the database 16 include media that can be read by the CPUs (110, 140, 170). Therefore, each of these types of memories includes a data processing system readable medium. These memories may be internal or external to the client computer 11, the web server 14, the application server 17, or any combination thereof.

Portions of the methods described herein may be implemented in suitable software code that includes instructions for carrying out the methods. In one embodiment, the instructions may be lines of assembly code or compiled C⁺⁺, Java, or other language code. Part or all of the code may be stored within memory the client computer 11, the web server 14, the database 16, the application server 17, or any combination thereof and executed by one or more CPU within the client computer 11, the web server 14, the application server 17, or any combination thereof. In another embodiment, the code may be contained on a data storage device, such as a magnetic tape, floppy diskette, CD ROM, optical or other storage device, storage network, other appropriate data processing system readable medium, or any combination thereof.

Other hardware architectures may be used. More or fewer servers may be present in other embodiments. For example, the functions of the application server 17 may be performed at least in part by the web server 14, and vice versa. Additionally, a software program or its software components with such code may be embodied in more than one data processing system readable medium in more than one computer or server. After reading this specification, skilled artisans appreciate that many other configurations are possible. The configuration illustrated in FIG. 1 or described herein is to be viewed as exemplary and not limiting.

Attention is now directed to specific aspects of using the workflow with the system described with respect to the system illustrated in FIG. 1. For simplicity, all actions performed are recited from the perspective of the web server 14 unless stated otherwise. The web server 14 can also be used to interact with the client computer 11, or render information that will be displayed at the monitor 12, or both.

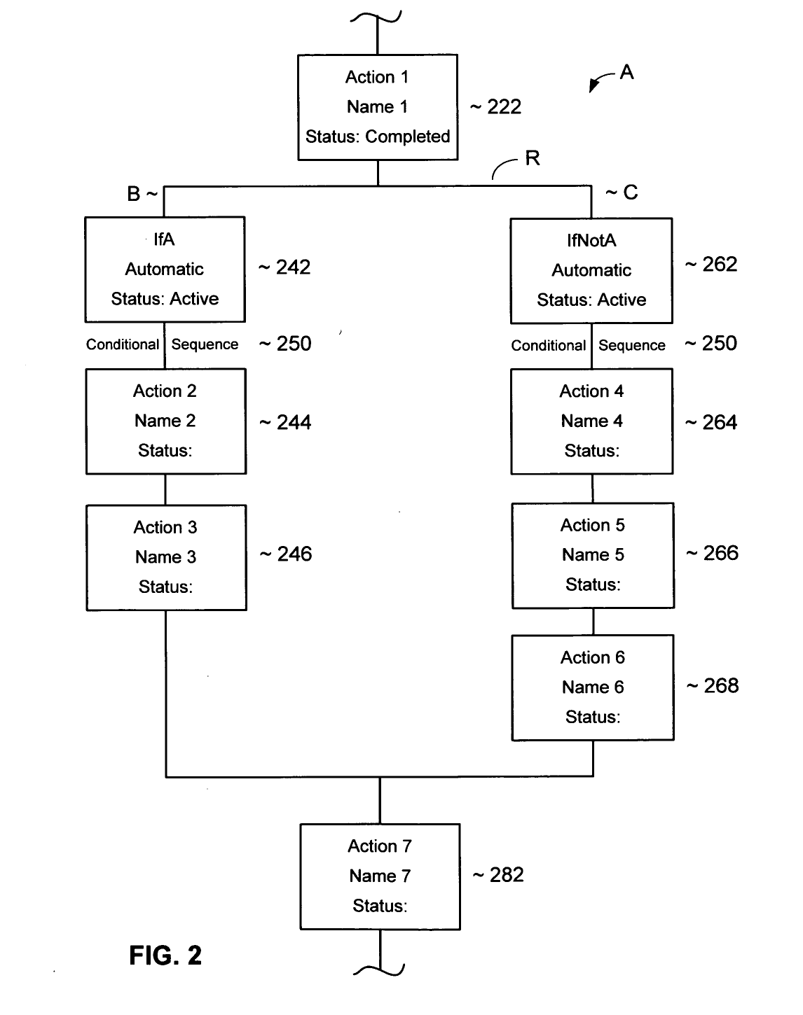

FIG. 2 includes an illustration of a portion of a workflow in accordance with an embodiment. The portion of a workflow includes column A that includes row element R having a pair of columns B and C that are connected in parallel. Each of the action elements within the columns B and C can include an action, a name or automatic indicator, a status, other information, or any combination thereof.

An example of an action can be highly variable. If an action is to be performed by the web server 14 or the application server 17, the action can be identified as an “execute” type of action. The action can also include an identifier that specifically states what action is to occur for that particular action element. For example, “Execute: IfA,” can correspond to determining whether condition A is present or has already occurred. Condition A can be an event, the presence or absence of a document or other item, a numerical comparison, or the like. Another example of an action includes creating a document, and still another example can include an automatic scoring of a stage within the workflow. After reading this specification, skilled artisans will appreciate that many other actions are possible.

The name can correspond to a person, a group of people, a department of an entity, or any combination thereof that is responsible for performing or ensure that the action is completed. The word “Automatic” or similar indicator can be used instead of a name to indicate that a computer, a server, other machine, or any combination thereof will perform the action. In one particular embodiment, no human interaction is required to complete the action when indicated as automatic.

The status can include information regarding the current status of an action element. Initially, the statuses of all action elements may be blank, set to zero, assigned a null value or other indicator to illustrate that the workflow has not yet reached that particular action element. When the action corresponding to an action element has been completed, a completed action signal can be generated, and the action element can be indicated as completed. After an action element is indicated as completed, status information regarding the completion can be pushed to other parts (as opposed to being pulled by the other parts) of the web server 14, to the database 16, to the application server 17, to the client computer 11, or any combination thereof. Any one or more subsequent actions that refer to that action can be activated, and statuses for corresponding action element(s) may be changed to indicate that those action element(s) are now active. If conditional logic has been performed and subsequent actions within a column do not need to be performed, the corresponding elements within the column can be bypassed and indicated accordingly. Again, any time status information for a element within the workflow changes, the changed status information can be pushed to other parts of the web server 14, to the database 16, to the application server 17, to the client computer 11, or any combination thereof.

Referring to FIG. 2, action element 222 includes Action 1 that is to be performed by a Name 1. After action element 222, a first set of actions lie within a column B that includes action elements 242, 244, and 246, and a second set of actions lie within another column C that includes action elements 262, 264, 266, and 268. As illustrated in FIG. 2, the two columns are connected in parallel. In another embodiment, more columns may be used, and the number of action elements within each column can be more or fewer than illustrated. The entire portion of the workflow as illustrated in FIG. 2 is part of column A. The portion illustrated consists of action element 222, a row element R containing the two columns B and C, and finally action element 282. Alternatively, corresponding elements of each column (242 and 262, 244 and 264, 246 and 266, and finally 268 by itself) might be considered rows, but this might imply some logical relationship within each of these pairs, and the point of the columns being considered as parallel is that actions within one column may be independent (in control and timing) of anything in another column.

At a particular point in time, the status of action element 222 is completed. As Action 1 is completed, a software program operating within the web server 14 can receive a completed action signal corresponding to action element 222 being completed. In one embodiment, the status information (e.g., action element 222 is indicated as completed) can be pushed. Column A, row element R, columns B and C, the first action elements of each column (242 and 262), or any combination thereof can be indicated as being active after action element 222 is completed. In one embodiment, the row element R, column B, column C, action element 242, action element 262, or any combination thereof can include a reference to action element 222, such that when action element 222 is completed, the row element, action element 242, action element 262, or any combination thereof is to become active. Activation signals for columns B and C and action elements 242 and 262 are generated, so that action elements 242 and 262 become active, and corresponding status information is pushed to other parts of the system. In one embodiment, the status of action elements 244, 246, 264, 266, and 268 are blank because the workflow has not yet reached those action elements. In a particular embodiment, each of the columns includes a conditional sequence indicator 250 because action elements 242 and 262 include conditional logic that will be automatically performed.

In FIG. 2 and other illustrations of workflows, the status of column and row elements are not displayed. Such information may be within one or more tables within database 16. In another embodiment, status information regarding column and row elements can be displayed.

Before continuing with the description of the workflow in FIG. 2 and the methodology associated therewith, an exemplary data structure and generation of the workflow are described. Regarding FIG. 2, a user at client computer 11, the web server 14, based at least in part from input signals received from a user and client computer 11, or both can generate action element 222. The web server 14 can provide the action description, name assignment or automatic indicator, status information, other information, or any combination thereof by using programmed logic within a software program, or by receiving user input signals that are transmitted from client computer 11 to the web server 14 via the client network 13. In one particular embodiment, action element 222 is assigned Action 1, Name 1, and initially has a blank status or may be assigned a null value or other indicator. Action element 222 may include a conditional logic test indicator or other flag to note that conditional logic associated with a bypass test is to be performed. In the particular embodiment as illustrated in FIG. 2, action element 222 will have a value for the conditional logic test indicator that corresponds to no bypass test is to be performed at action element 222.

In one embodiment, an “insert under” command is executed, which initially creates another action element, which can be action element 242. The command is used to note that the action element is the next item in the workflow sequence. The user at client computer 11, the web server 14, the application server 17, or any combination thereof can initiate the “insert under” command and provide information for the newly created action element 242. From action element 242, a subsequent “insert right” command is used to note that a plurality of parallel columns is being formed initially comprised of this action element 242 in one column B and a newly created action element 262 in the second column C. The two columns B and C together comprise a new row element R that is also created by this “insert right” command, which takes the place of action element 242 as the second element of the original column A. Each of action elements 242 and 262 can include a reference to the columns B and C, respectively, and the columns B and C can include a reference to row element R, and the row element can include a reference to action element 222. From action element 242, an “insert under” command can be used to create action element 244, and another “insert under” command can be used to create action element 246. From action element 262, “insert under” commands can be used to create action elements 264, 266, and 268 in a similar manner. After reading this specification, skilled artisans will appreciate that different names for the commands can be used, that the commands may be changed (e.g., “insert right” command if a column within a row element is conditionally performed and “insert left” command if a column within the row element is not conditionally performed (i.e., will be performed)), the order in which the workflow in generated can be changed, or any combination thereof can be performed without departing from the scope of the present invention.

Action element 242 includes an action for performing conditional logic. When action element 242 is created, a conditional logic test indicator (e.g., a flag) for action element 242 is assigned a value that denotes that the remainder of the one or more actions within the column are conditional, based on the result of a conditional logic test (also called a “bypass test”) that will be performed when using the workflow. In one particular embodiment, the action includes “IfA.” When using the workflow, the method will include determining whether condition A is present or has occurred when the workflow reaches action element 242. The outcome of the test will be described in more detail later in this specification.

The action element 244 includes a reference to the action element 242, so that when a completed action signal for action element 242 is pushed, an activation signal can be generated that activates the action element 244. Referring to the action element 244, it includes Action 2, is assigned to Name 2, and will display a status when the workflow is used. In one particular embodiment, the conditional logic test indicator for the action element 244 is assigned a value that denotes that the action element 244 does not include conditional logic. The action element 246 includes a reference to the action element 244. In one particular embodiment, the conditional logic test indicator for the action element 246 is assigned a value that denotes that the action element 246 does not include conditional logic. The action element 246 includes Action 3, is assigned to Name 3, and will display a status when the workflow is used.

Referring back to the row element, information corresponding to action element 262 can be added in a manner similar to action element 242. The action element 262 includes an action for performing conditional logic. When action element 262 is created, a conditional logic test indicator for action element 262 is assigned a value that denotes that the remainder of the one or more actions within the column is conditional, based on the result of a bypass test that will be performed when using the workflow. In one particular embodiment, the action includes “IfNotA.” Note that action element 262 has logic that is the opposite of the action element 242 (action elements 242 and 262 are mutually exclusive in this particular embodiment). When using the workflow at action element 262, the method will include determining whether condition A is not present or has not occurred. The outcome of the test will be described in more detail later in this specification.

The action elements 264, 266, and 268 are created and information is provided in a manner similar to action elements 244 and 246. The action element 264 includes a reference to the action element 262, the action element 266 includes a reference to the action element 264, and the action element 266 includes a reference to the action element 264. In one particular embodiment, the conditional logic test indicators for the action elements 264, 266, and 268 are assigned values that denote that the action elements 264, 266, and 268 do not include conditional logic.

After the columns, including the action elements in the columns and their corresponding information, have been generated, the cursor or other indicator is moved to the row element, and an “insert under” command can be used to create action element 282. The action element 282 includes a reference to the row element and will be performed after the row element is indicated as being completed. The information within the action element 282 for this particular embodiment is similar to the action elements 244, 246, 264, 266, and 268. In one particular embodiment, the conditional logic test indicator for the action element 282 is assigned a value that denotes that the action element 282 does not include conditional logic. The action element 282 includes Action 7, is assigned to Name 7, and will display a status when the workflow is used.

The generation of the workflow can continue in a similar manner. Although different actions and different names are assigned to each of the action elements within FIG. 2, the same or similar actions or the same name may be used in different action elements. As previously described, references between any two elements may be direct or indirect. After the workflow has been generated or as it is being generated, the workflow or different portions of the workflow can be stored within the database 16, HD 176, HD146, HD 116, or any combination thereof.

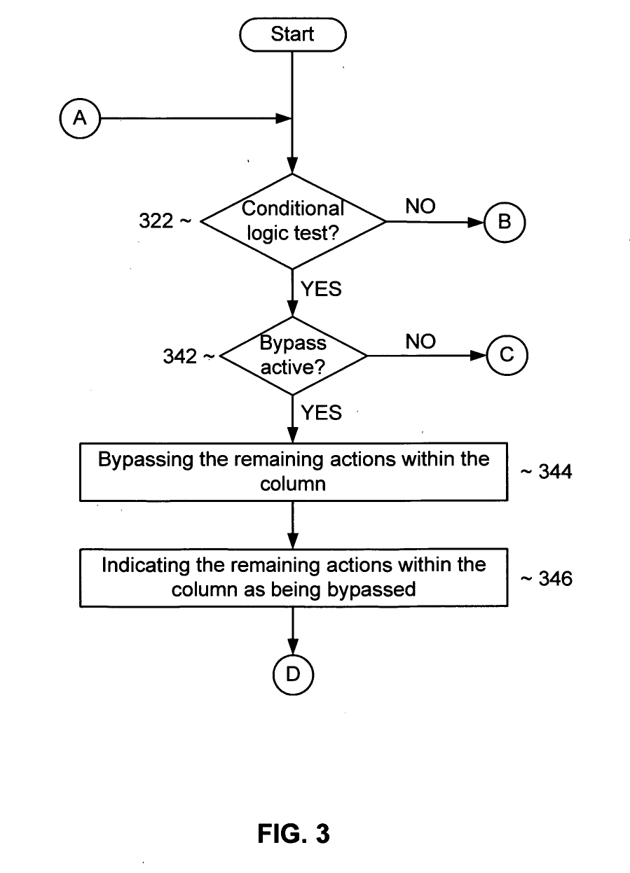

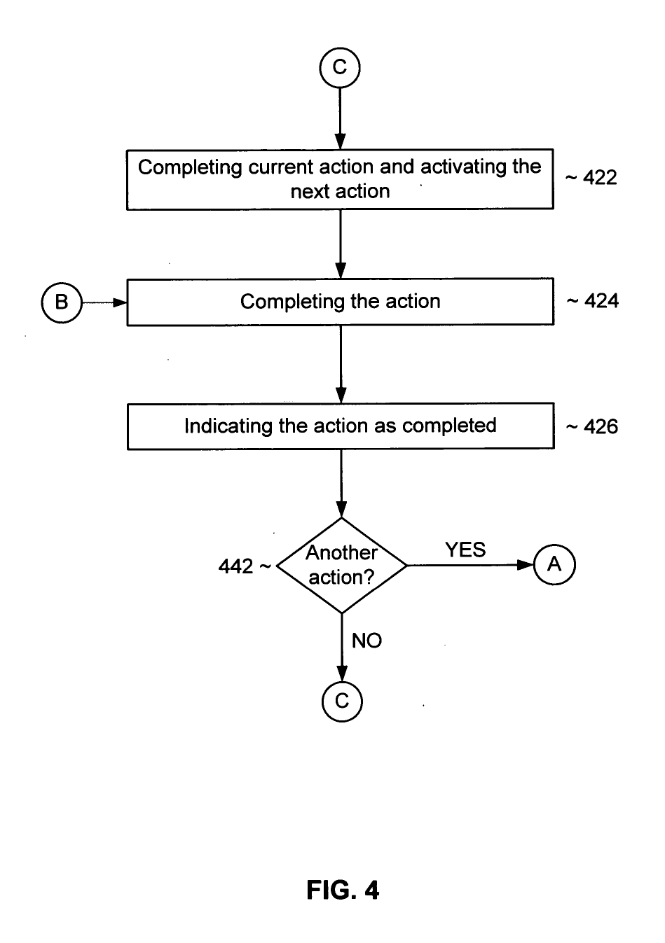

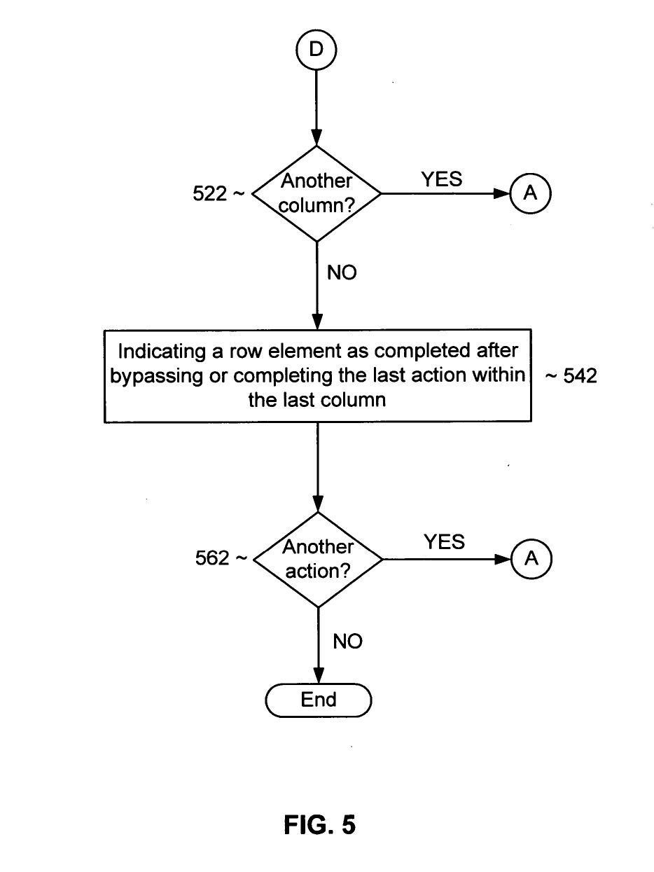

After the workflow has been generated, it can be used by an entity to execute on the actions within the workflow. The workflow may correspond to a project, a set of projects, a strategy, or the like. One exemplary, non-limiting embodiment for using the workflow is described with respect to the flowchart and FIGS. 3 through 5 with reference to portions of the workflows, as illustrated in FIGS. 2, 6, and 7. FIG. 3 generally corresponds to conditional logic and bypass operations, FIG. 4 generally corresponds to a non-conditional action, and FIG. 5 generally corresponds to completing operations for a row element. In one particular embodiment, the web server 14 performs the method when using the workflow, unless indicated otherwise. In another embodiment, portions of the method can be performed by the application server 17, the client computer 11 (or a user at the client computer 11), or any combination thereof.

The web server 14 can retrieve the workflow from the database 16, via the network 15, if the workflow is not already at the web server 14. A portion or all of the workflow may be written into ROM 142, RAM 144, or HD 146 while the CPU 140 executes logic associated with the workflow.

Referring briefly to FIG. 2, Action 1 in action element 222 has just been completed, and the web server 14 can generate or receive a completed action signal. Although not illustrated in FIG. 2, the CPU 140 can determine that a row element R references action element 222 and that action elements 242 and 262 have references to row element R. The CPU 140 within the web server 14 can generate activation signals to activate the first action elements (action elements 242 and 262) within each of the columns B and C that reference the row element R. Each of the first action elements within the columns B and C may have their status changed to indicate they are currently active. The completed action signal and activation signals can be pushed by the CPU 140 to other parts of the system, such as updating the statuses of action elements 222, 242, and 262 in database 16, providing the information to application server 17, the client computer 11, or any combination thereof.

At this point in the process, as illustrated in FIG. 3, the method can include determining whether a conditional logic test is to be performed (diamond 322). Referring to action element 242 in FIG. 2, the CPU 140 within web server 14 can examine the value of the conditional logic test indicator for action element 242 and determine that a test is to be performed. In one embodiment, the web server 14 can optionally generate a conditional logic test signal. If a conditional logic test is to be performed (“YES” branch from diamond 322), the method can continue as illustrated in FIG. 3. Otherwise (“NO” branch from diamond 322), the method continues with the flow as illustrated in FIG. 4. Because action element 242 includes a conditional logic test indicator having a value corresponding to performing a conditional test, the method continues with the flow as illustrate in FIG. 3.

Regarding action element 242, the method can also include performing a test to determining whether a bypass function is to be activated. In one embodiment, the logic used is such that if the condition is present or has already occurred, the bypass will be activated and the element will be executed. In another embodiment, the opposite logic can be used (bypass activated if the condition is not present or has not already occurred). In a particular embodiment, action element 242 includes a test “IfA,” which can mean if condition A is not present or has not already occurred, then the method can include bypassing the remaining actions within the column (block 344 in FIG. 3) and indicating the remaining actions within the column as being bypassed (block 346). In one embodiment, the CPU 140 can generate a bypass activation signal to note that action elements 244 and 246 are being bypassed because condition A is not present or has not already occurred. Status information can indicate action element 242 and column B is completed and action elements 244 and 246 are bypassed. The status information can be pushed to other parts of the system.

The method can continue as illustrated FIG. 5 and include determining whether the row element has another column (diamond 522). Referring to FIG. 2, the column C still needs to be completed. The method can include determining whether a bypass test is to be performed (return to diamond 322 in FIG. 3). Regarding the action element 262, its conditional logic test indicator has a value that indicates that a bypass test is to be performed. In action element 262, the test is “IfNotA,” which can mean determine if condition A is not present or has not already occurred.

If condition A is not present or has not already occurred (“NO” branch from diamond 342), the method can include completing the current action and activating the next action (block 422 in FIG. 4). The CPU 140 can generate an activation signal for action element 264 in FIG. 2. In one embodiment, after the bypass activation test is completed (diamond 342), a completed action signal can be generated by the CPU 140 for action element 262 in FIG. 2, which in turn can be used by the CPU 140 to generate an activation signal for action element 264 in FIG. 2. Status information can indicate action element 262 is completed and action element 264 is active. The status information can be pushed to other parts of the system.

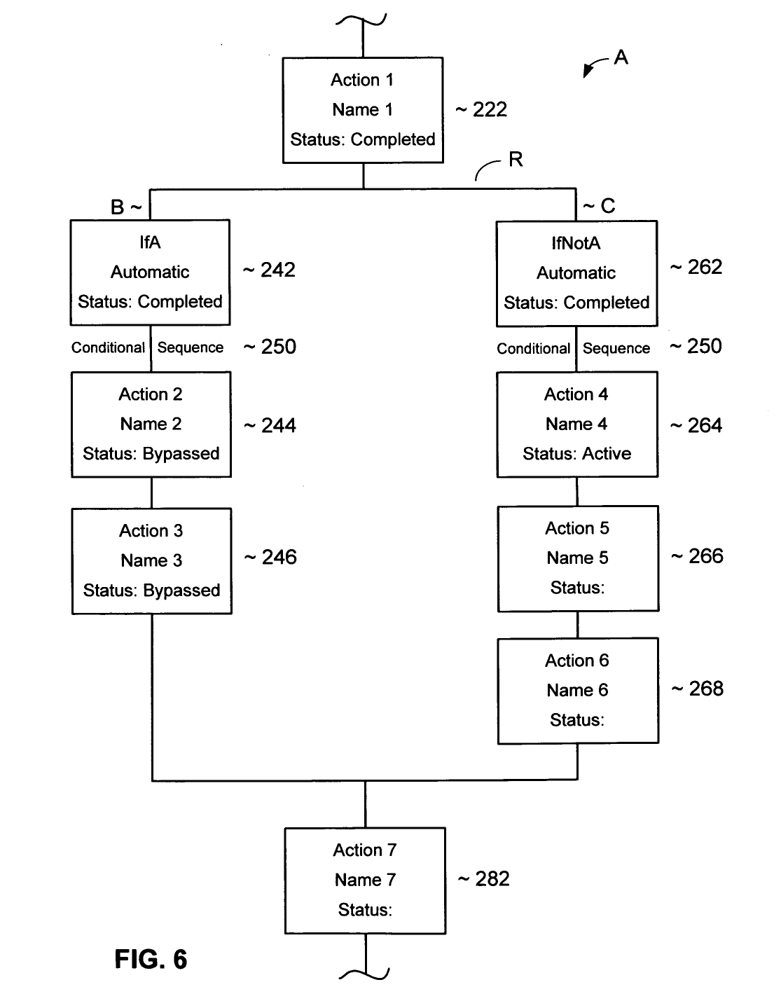

FIG. 6 includes an illustration of the workflow at this point in time. The web server 14 can render a web page in the form of display signals that are transmitted to the client computer 11 and displayed at monitor 12. Action elements 242 and 262 are indicated as completed, action elements 244 and 246 are indicated as bypassed, action element 264 is indicated as active, and action elements 266, 268 and 282 have not yet been reached.

The method can continue with completing the action (block 424 in FIG. 4) and indicating the action as completed (block 426). The action can be highly variable, and therefore, the manner in which the action is completed is also highly variable. Referring to action element 264 in FIG. 2, Name 4 is responsible for completing Action 4. Action 4 may include generating a document, determining a score, approving a plan, or the like. In one embodiment, upon completion of Action 4, a user input signal from client computer 11 can be transmitted to the web server 14. The user input signal can include expressed information upon completion or can be saving a document or transmitting a score or approval (or disapproval). The system is flexible and can explicitly or may implicitly determine completion, if desired. Upon completion, the CPU 140 can generate a completed action signal, which can be used to update the status of action element 264 and push such status information to other parts of the system.

The method can include determining whether another element is within the same column (diamond 442 in FIG. 4). In one embodiment, the CPU 140 can determine that action element 266 references action element 264 and may generate an activation signal in response to the completed action signal for 264 and determine that action element 266 references action element 264. The method returns to diamond 322 in FIG. 3. If at this point the next element in this column is a row element, the method can invoke itself recursively to activate the row element, each column element for that row element, and the first element of each column as previously described. In the particular embodiment having the workflow as illustrated in FIG. 2, at this point the following element is an individual action rather than a row element, but if a row had been encountered at this point, the recursive processing could activate each column and proceed through each column as described in herein and illustrated in FIGS. 3 to 5 completing all automatic actions encountered until an action element is encountered which requires user interaction. At that point, the recursive execution for that column could activate that action element, sending signals as needed to other components to deliver notification to the user, and exit to the recursive loop handling the row object, to activate the next column in turn until all columns had been activated.) After the CPU 140 determines that the conditional logic test indicator has a value corresponding to no conditional logic test (“NO” branch of diamond 322), the method continues with block 424, block 426, and diamond 442 in FIG. 4.

The method used for action elements 266 and 268 are substantially similar. Appropriate completed action signals for the action elements and status information can be generated and pushed. After the action element 268 is completed, the CPU 140 can determine that action element 268 is the last action in the column (“NO” branch from diamond 442) because no other action elements within the same column reference action element 268 as being a preceding action. The method continues as illustrated in FIG. 5. Status information can indicate action elements 264, 266, and 268, and column C are completed. The status information can be pushed to other parts of the system

The method can include determining whether the row element has another column that has not been completed or bypassed (diamond 522 in FIG. 5). At this point, the method continues along the “NO” branch from diamond 522. The method can include indicating the row element as completed after bypassing or completing the last action within the last column (block 542). The last column refers to the column that is temporally the last to be bypassed or completed, not necessarily the last column with respect to location of the column with respect to the other columns (i.e., positional relationship between the columns within the workflow) for the row element. All action elements within the two columns for the row element are completed. Therefore, the CPU 140 can generate a row completed signal for row element R.

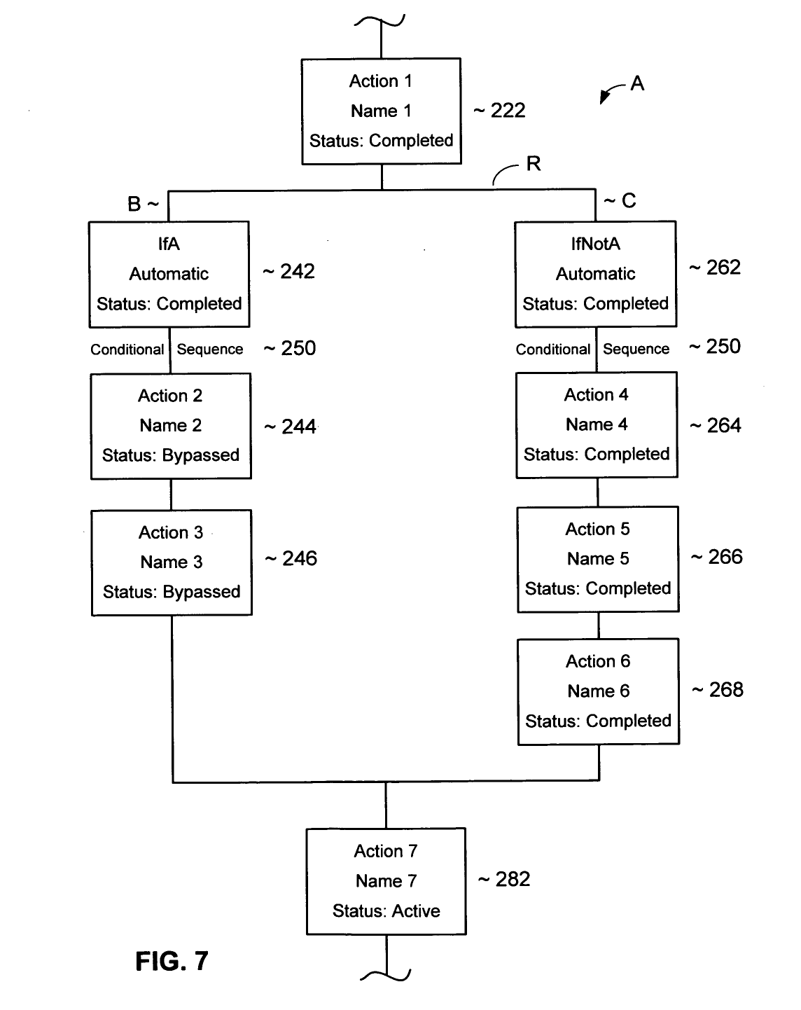

The method can further include determining if the workflow has another action (diamond 562). The CPU 140 can generate an activation signal for action element 282 in response to the row completion and determining that the action element 282 references the row element. The CPU 140 can push status information to other parts of the system. FIG. 7 illustrates an illustration of a display of the workflow at this point in time. Action element 282 is now active, and the other action elements in FIG. 7 are indicated as completed or bypassed. The method can proceed with the bypass test determination (diamond 322 in FIG. 7) and continue in a manner as described herein.

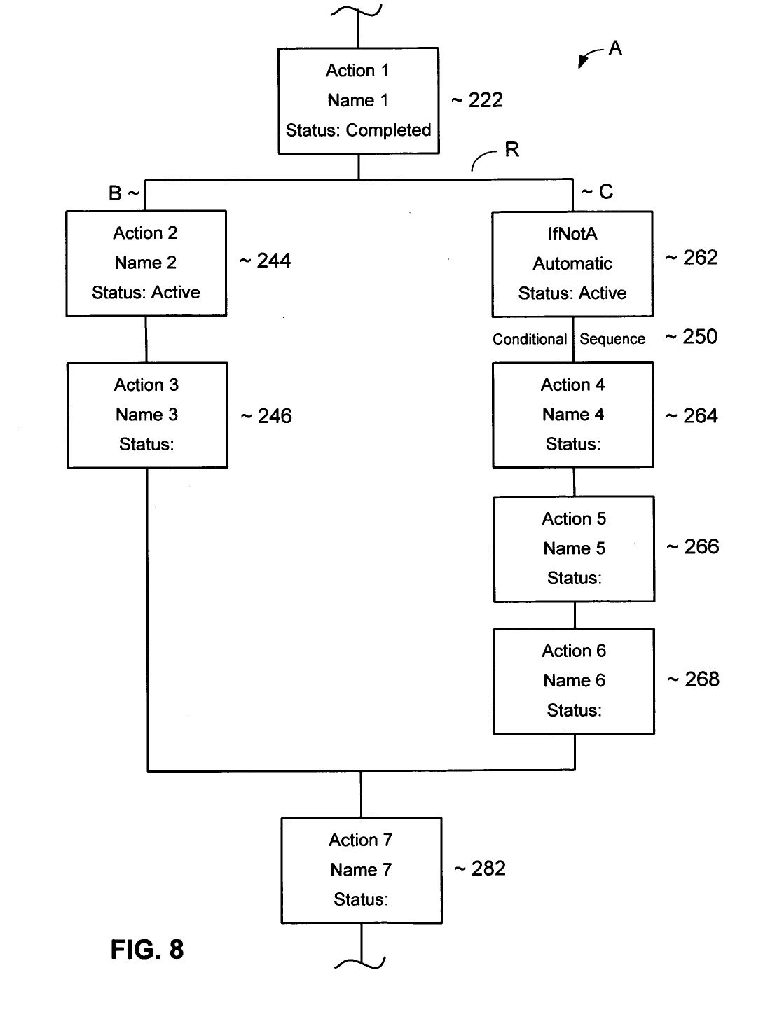

The system and methods described are highly flexible and can be used for many different workflows. FIG. 8 includes a portion of a workflow in which the action elements 244 and 246 are not conditional and will be performed. The actions for action elements 264, 266, and 268 still depend on the conditional logic test in the action element 262.

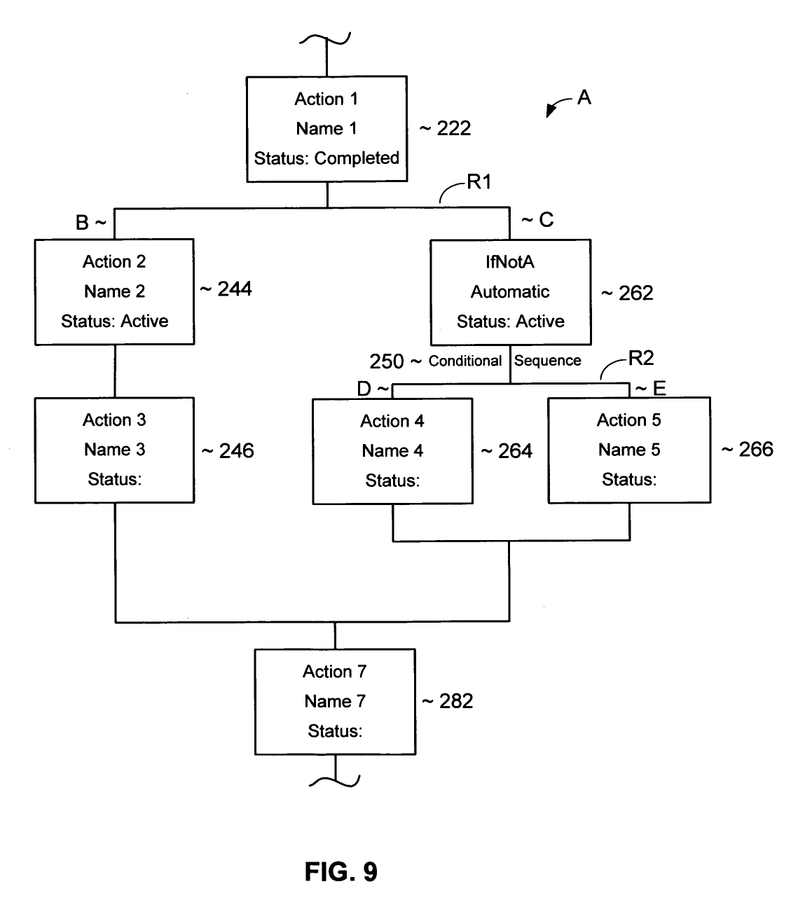

FIG. 9 includes a portion of another workflow in which row elements are nested. A first row element R1 is associated with columns B and C and action elements 244 and 262. A second row element R2 is associated with columns D and E and action elements 264 and 266. From a data structure perspective, the second row element R2 lies within the same column R1 as action element 262. If condition A is present or has occurred, the CPU 140 will iterate the methodology to bypass each action (or further nested row element and its associated action elements, if any would exist) for each column associated with the second row element R2 and indicate the bypassing accordingly. The second row element R2 can be indicated as completed, or optionally bypassed. The first row element R1 is now completed and can be indicated accordingly.

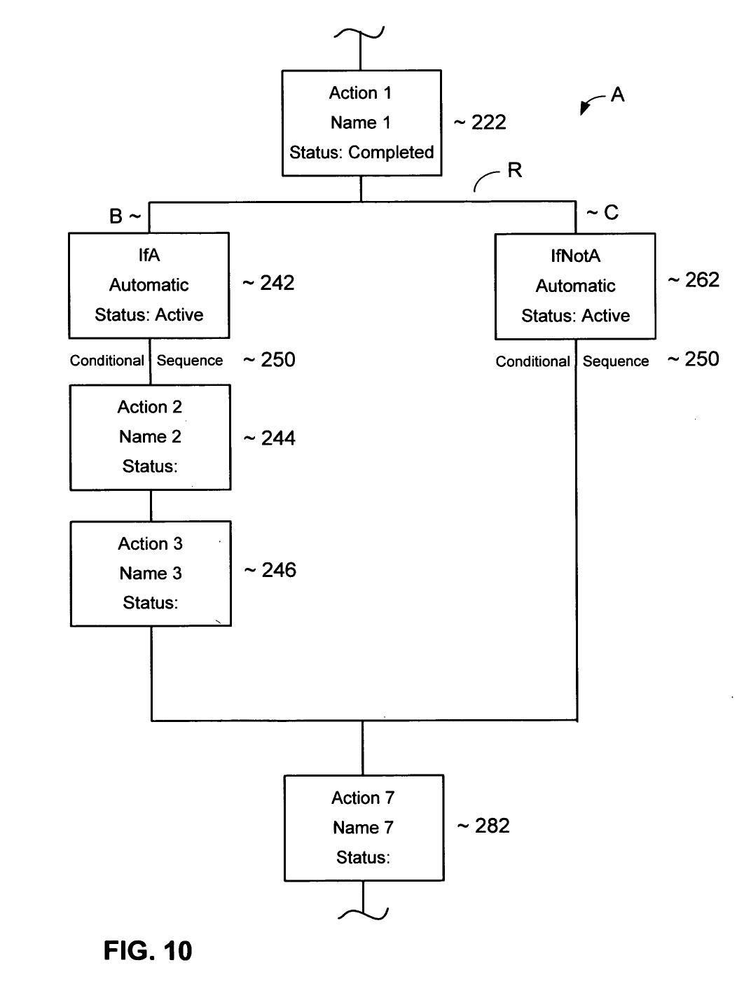

FIG. 10 includes a portion of still another workflow in which some actions are optional, however, if they are to be performed, they are performed serially with respect to the other actions. For example, Action 1 and Action 7 will be performed. However, Actions 2 and 3 may or may not be performed. If Actions 2 and 3 are to be performed, the order of performance is Action 1, Action 2, Action 3, and then Action 7. The conditional logic within action elements 242 and 262 can be used in the manner as illustrated in FIG. 10 when Actions 2 and 3, within a sequence, are optional. Note that no other action elements lie along the column with action element 262. In another embodiment, the action element 262 can be a dummy element, rather than including conditional logic. In this embodiment, the CPU 140 can activate the action element 262 and indicate it as being completed as soon as it is activated because action element 262 is a dummy element.

The methods, systems, or any portion thereof can be implemented to allow greater flexibility when generating a workflow that includes parallel columns that have actions that may or may not need to be performed, as can be determined after the workflow is generated and is being used. Complex workflows can be generated with nearly any number and organization of rows and columns. The bypass function can allow the automated processing to bypass a plurality of actions and to do so accurately. Single action skipping and errors related to humans performing single action skips can be significantly reduced.

Any portion of all of the methods described herein may be performed by a computer, server, or other machine. Instructions can be generated that correspond to the operations described herein.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a method of using a workflow can include performing a conditional logic test to obtain a result and automatically bypassing a plurality of actions within a first set of actions in response to the result from a conditional logic test.

In one embodiment of the first aspect, the method further includes detecting a conditional logic test indicator, wherein the conditional logic test indicator is associated with the plurality of actions within the first set of actions. In another embodiment, the method further includes indicating each action within the plurality of actions as being bypassed. In a particular embodiment, the first set of actions includes a series of actions within a column, and the plurality of actions is remaining actions within the column. In another particular embodiment, the method further includes indicating each action within a second set of actions as completed, wherein the second set of actions is in parallel with the first set of actions. The method further includes indicating a row element associated with the first and second sets of actions as completed after a last action within the first set of actions is bypassed and after receiving a completing action signal associated with a last action within the second set of actions. In a still another particular embodiment, a row element lies within the plurality of actions, the row element has corresponding columns, and indicating each action includes indicating each action within the columns as being bypassed and indicating the row element as being completed or bypassed.

In a further embodiment of the first aspect, the workflow includes a first column and a second column, the first column includes the plurality of actions, and the second column only includes the conditional logic test or a dummy element. In still a further embodiment, the method further includes transmitting a display signal that includes a portion of the workflow, wherein the display signal includes an indicator that the plurality of actions are within a conditional sequence.

In a second aspect, a data processing system readable medium can have code to use a workflow, wherein the code is embodied within the data processing system readable medium. The code can include an instruction to perform a conditional logic test to obtain a result and an instruction to bypass a plurality of actions within a first set of actions in response to the result from a conditional logic test.

In one embodiment of the second aspect, the code further includes an instruction to detect a conditional logic test indicator, wherein the conditional logic test indicator is associated with the plurality of actions within the first set of actions. In another embodiment, the code further includes an instruction to indicate each action within the plurality of actions as being bypassed. In a particular embodiment, the first set of actions includes a series of actions within a column, and the plurality of actions is remaining actions within the column. In another particular embodiment, the code further includes an instruction to indicate each action within a second set of actions as completed after the each action is completed, wherein the second set of actions is in parallel with the first set of actions. The code can still further include an instruction to indicate a row element associated with the first and second sets of actions as completed after receiving a bypassed signal for a last action within the first set of actions and after receiving a completed action signal associated with a last action within the second set of actions. In still another particular embodiment, a row element lies within the plurality of actions, the row element has corresponding columns, and the instruction to indicate each action includes an instruction to indicate each action within the columns as being bypassed and an instruction to indicate the row element as being complete.

In a further embodiment of the second aspect, the workflow includes a first column and a second column, the first column includes the plurality of actions, and the second column only includes the conditional logic test or a dummy element. In still a further embodiment, the code further includes an instruction to transmit a display signal that includes a portion of the workflow, wherein the display signal includes an indicator that the plurality of actions are within a conditional sequence.

In a third aspect, a data processing system readable medium can have code to use when processing a workflow, wherein the code is embodied within the data processing system readable medium. The code can include an instruction to determine a result of a conditional logic test associated with a first set of actions, wherein the first set of actions includes a series of actions within a column, an instruction to bypass a plurality of actions within the first set of actions in response to the result from the conditional logic test, wherein the plurality of actions are remaining actions within the column, and an instruction to indicate each action within the plurality of actions as being bypassed. The code can also include an instruction to indicate each action within the second set of actions as completed after the each action within the second set of actions is completed, wherein the second set of actions is in parallel to the first set of actions, and an instruction to indicate a row element associated with the first and second sets of actions as completed after bypassing a last action within the first set of actions and after completing a last action within the second set of actions.

In one embodiment of the third aspect, another row element lies within the first set of actions, the other row element has corresponding columns, and the instruction to indicate each action includes an instruction to indicate each action within the corresponding columns as being bypassed and an instruction to indicate the other row element as being bypassed or completed.

In any of the aspects and embodiments described herein, a data processing system can include any one or more data processing system readable media described herein, can be configured to perform any one or more methods described herein, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of using a workflow comprising:
performing a conditional logic test to obtain a result;
automatically bypassing a plurality of actions within a first set of actions in response to the result from a conditional logic test.

2. The method of claim 1, further comprising detecting a conditional logic test indicator, wherein the conditional logic test indicator is associated with the plurality of actions within the first set of actions.

3. The method of claim 1, further comprising indicating each action within the plurality of actions as being bypassed.

4. The method of claim 3, wherein:
the first set of actions includes a series of actions within a column; and
the plurality of actions is remaining actions within the column.

5. The method of claim 3, further comprising:
indicating each action within a second set of actions as completed, wherein the second set of actions is in parallel with the first set of actions; and
indicating a row element associated with the first and second sets of actions as completed after a last action within the first set of actions is bypassed and after receiving a completed action signal associated with a last action within the second set of actions.

6. The method of claim 3, wherein:
a row element lies within the plurality of actions;
the row element has corresponding columns; and
indicating each action comprises indicating each action within the columns as being bypassed and indicating the row element as being completed or bypassed.

7. The method of claim 1, wherein:
the workflow includes a first column and a second column;
the first column includes the plurality of actions; and
the second column only includes the conditional logic test or a dummy element.

8. The method of claim 1, further comprising transmitting a display signal that includes a portion of the workflow, wherein the display signal includes an indicator that the plurality of actions are within a conditional sequence.

9. A data processing system configured to perform the method of claim 1.

10. A data processing system readable medium having code to use a workflow, wherein the code is embodied within the data processing system readable medium, the code comprising:
an instruction to perform a conditional logic test to obtain a result; and
an instruction to bypass a plurality of actions within a first set of actions in response to the result from a conditional logic test.

11. The data processing system readable medium of claim 10, wherein the code further comprises an instruction to detect a conditional logic test indicator, wherein the conditional logic test indicator is associated with the plurality of actions within the first set of actions.

12. The data processing system readable medium of claim 10, wherein the code further comprises an instruction to indicate each action within the plurality of actions as being bypassed.

13. The data processing system readable medium of claim 12, wherein:
the first set of actions includes a series of actions within a column; and
the plurality of actions is remaining actions within the column.

14. The data processing system readable medium of claim 12, wherein the code further comprises:
an instruction to indicate each action within a second set of actions as completed after the each action is completed, wherein the second set of actions is in parallel with the first set of actions; and
an instruction to indicate a row element associated with the first and second sets of actions as completed after receiving a bypassed signal for a last action within the first set of actions and after receiving a completed action signal associated with a last action within the second set of actions.

15. The data processing system readable medium of claim 12, wherein:
a row element lies within the plurality of actions;
the row element has corresponding columns; and
the instruction to indicate each action comprises an instruction to indicate each action within the columns as being bypassed and an instruction to indicate the row element as being complete.

16. The data processing system readable medium of claim 10, wherein:
the workflow includes a first column and a second column;
the first column includes the plurality of actions; and
the second column only includes a conditional logic test or a dummy element.

17. The data processing system readable medium of claim 10, wherein the code further comprises an instruction to transmit a display signal that includes a portion of the workflow, wherein the display signal includes an indicator that the plurality of actions are within a conditional sequence.

18. A data processing system comprising the data processing system readable medium of claim 10.

19. A data processing system readable medium having code to use when processing a workflow, wherein the code is embodied within the data processing system readable medium, the code comprising:
an instruction to determine a result of a conditional logic test associated with a first set of actions, wherein the first set of actions includes a series of actions within a column;
an instruction to bypass a plurality of actions within the first set of actions in response to the result from the conditional logic test, wherein the plurality of actions are remaining actions within the column;
an instruction to indicate each action within the plurality of actions as being bypassed;
an instruction to indicate each action within the second set of actions as completed after the each action within the second set of actions is completed, wherein the second set of actions is in parallel to the first set of actions; and
an instruction to indicate a row element associated with the first and second sets of actions as completed after bypassing a last action within the first set of actions and after completing a last action within the second set of actions.

20. The data processing system readable medium of claim 19, wherein:
another row element lies within the first set of actions;
the other row element has corresponding columns; and
the instruction to indicate each action comprises an instruction to indicate each action within the corresponding columns as being bypassed and an instruction to indicate the other row element as being bypassed or completed.

21. A data processing system comprising the data processing system readable medium of claim 19.
